(19) United States
(12) Patent Application Publication
(10) Pub. No.: US 2012/0327212 A1
(43) Pub. Date: Dec. 27, 2012

(54) SEM TYPE DEFECT OBSERVATION DEVICE AND DEFECT IMAGE ACQUIRING METHOD

(75) Inventors: Katsuhiro Kitahashi, Hitachinaka (JP); Kazuo Aoki, Hitachinaka (JP); Masashi Sakamoto, Hitachinaka (JP); Katsuaki Abe, Hitachinaka (JP)

(73) Assignee: HITACHI HIGH-TECHNOLOGIES CORPORATION, Tokyo (JP)

(21) Appl. No.: 13/580,259

(22) PCT Filed: Dec. 1, 2010
(86) PCT No.: PCT/JP2010/006999

§ 371 Date: Aug. 21, 2012

(30) Foreign Application Priority Data
Mar. 15, 2010 (JP) 2010-056901

(51) Int. Cl. H04N 7/18

(52) U.S. Cl. 348/80; 348/E07.085

(57) ABSTRACT

The present invention enables provision of a defect observation device that reduces wait time from an end of pickup of a reference image and accompanying processing to a start of pickup of a defect image compared to conventional ones by making a pixel count resolution of the reference image be low compared to a pixel count of the defect image in an image pickup unit using an electronic microscope for automatic fine defect classification, whereby a throughput enhanced compared to those of conventional ones can be achieved.

### TECHNICAL FIELD

The present invention relates to a method and device for acquiring an image of an industrial product, and specifically relates to a device and method for acquiring an image using an electronic microscope in order to automatically classify, e.g., a fine foreign substance or a pattern defect generated during a semiconductor product manufacturing process.

### BACKGROUND ART

In a semiconductor product manufacturing process, the yield may be lowered by, e.g., short-circuiting caused by foreign substances in formed patterns of semiconductors or disconnection defects occurring in the manufacturing apparatus. Therefore, quickly identifying the causes of the defects and taking countermeasures therefor are important for enhancement of the yield.

Meanwhile, a technique in which after an inspection by a semiconductor wafer outer appearance inspection device, an image acquired during the inspection is analyzed to automatically classify a defect or a technique in which after an inspection by a semiconductor wafer outer appearance inspection device, a higher-definition image of a defect portion is acquired based on information on the position of the defect acquired by the inspection to automatically classify the image (ADC: automatic defect classification) has been proposed as an effort to enhance the yield by quickly identifying the cause of the defect based on the result of the classification and taking a countermeasure therefor.

In recent years, patterns formed on semiconductor wafers are becoming finer and finer, and accompanied by that, defects generated are also become finer and finer. Thus, for correct defect classification, it is necessary to acquire a defect image subjected to classification processing as a small-field, close-up image of a defect portion using, e.g., an electronic microscope. Meanwhile, there is a strenuous demand for the throughputs of in-line inspection devices used on the semiconductor device manufacturing lines, and thus, reducing the time required from acquisition of a defect image to automatic classification as much as possible is consistently demanded.

However, in the case of high-power image pickup units such as electronic microscopes, it is not so easy to set a field area so that a target defect is positioned in the center of the field. Therefore, conventionally, images in two types of viewing fields are acquired: a wide-field defect image including a defect portion and a reference image having a viewing field size that is the same as that of the defect image are acquired and the defect image and the reference image are subjected to image processing to calculate the center position of the defect and acquire a small-field image with the center position as the center thereof. For example, patent literature 1 discloses a method for acquiring defect images with the aforementioned two viewing field sizes.

Details of the flow of acquisition of defect images with the aforementioned two viewing field sizes will be described with reference to FIG. 7. First, based on known coordinates of a defect, the viewing field is moved close to the coordinates of the defect by moving the stage (step 701), and a reference image of a proper viewing field size is acquired (step 702). The image data obtained as a result of the image pickup is transferred via a data communication line (step 703). Output signals from an image detector used for image pickup are output in the form of successive data, and thus, captured by proper means and stored in storage means such as a memory or a hard disk (step 704). In parallel with execution of steps 703 and 704, the viewing field is moved by moving the stage (step 705) and a low-magnification defect image (defect image at a first magnification) is acquired under the conditions (e.g., magnification and/or scanning speed) that are similar to those for the reference image (step 706). After the image pickup, the data is transferred (step 707) and the low-magnification defect image is thereby captured and stored (step 708).

In parallel with execution of step 708, processing for calculating the position of the defect using an operation to compare the reference image and the defect image is performed (step 709), and after the calculation, the viewing field is moved by image shifting or stage movement so that the calculated center of the defect becomes the center of the viewing field (step 710). After the viewing field movement, the image pickup magnification of the optical system is increased and a high-magnification image of the target defect is picked up (step 711). The picked-up high-magnification image is subjected to data transfer (step 712) and stored in an external storage device (step 713), and furthermore, is subjected to defect classification processing (step 713). The defect classification processing may be performed after the end of the image pickup for all of defect points or may be performed in parallel with pickup of defect images.

For finer defects, the resolution of the image may be increased during execution of step 713 (acquisition of a small-field image). Here, “resolution is high” means that an image with an increased number of pixels is acquired with its viewing field size kept fixed. The increase in number of pixels of the image results in an increase in number of pixels corresponding to the defect portion included in the image, enabling finer defect detection using image processing.

### CITATION LIST

### Patent Literature

Patent Literature 1: Japanese Patent Publication (Kokai) No. 2000-030652A

### SUMMARY OF INVENTION

### Technical Problem

In order to observe a fine defect, it is necessary to an image at an increased magnification. However, information on the position of a defect that a defect observation device initially has is information acquired by an upstream outer appearance inspection device, and thus does not necessarily correspond to a position expressed by a coordinate system that the defect observation device has. Moreover, the difference between the information on the position of a defect that the defect observation device initially has and the true position of the defect (positional error) varies depending on the relative coordinate precision between the outer appearance inspection device and the defect image observation device. Furthermore, the precision of control of the stage movement that the defect observation device has also affects the difference. Accordingly, an image of a defect portion is not necessarily picked up in the center of the viewing field and as the magnification is higher, it is more highly likely that the defect portion falls out of the viewing field set in the observation device (in other words, the viewing field set based on the initial information on the position of the defect that the observation device has). As described above, there is a trade-off relationship between the technical problems of high-magnification image pickup and reliable defect catching.

Meanwhile, although an image ultimately required for defect classification is a high-magnification defect image picked up in step 711 in FIG. 7, in the conventional defect image acquisition flow illustrated in FIG. 7, the viewing field is moved three times, i.e., the time of pickup of a reference image, the time of pickup of a low-magnification defect image and the time of pickup of a high-magnification defect image to acquire an image ultimately required. From the perspective of throughput enhancement, it is effective to eliminate such viewing field movements to the maximum possible extent; however, the device has no coordinate precision sufficient for directly executing the high-magnification defect image step in step 711 after the end of step 702.

Therefore, an object of the present invention is to provide a defect observation device or a defect image acquiring method enabling provision of an enhanced throughput from image pickup to defect classification compared to conventional ones while maintaining an image resolution required for defect classification.

Also, in the case of the conventional two-viewing filed switching method, if the pixel count of a low-magnification defect image acquired with a first viewing field is increased, and it is necessary to also increase the pixel count of a reference image in line with such increased pixel count, and along with such increase, processing time for processing accompanied by the pickup of the reference image such as the data transfer time and the image processing time increases, causing the problem of the timing for starting the pickup of a low-magnification defect image or a high-magnification defect image being delayed.

Therefore, an object of another aspect of the present invention is to provide a defect observation device or a defect image acquiring method enabling a time lag from an end of pickup of a reference image and accompanying processing to a start of pickup of a defect image to be reduced compared to conventional ones.

### Solution to Problem

The present invention provides a defect observation device or a defect image acquiring method enabling a total throughout to be enhanced without performing the conventional two-viewing field size changing, by setting a viewing field size to a size wide enough to reliably catch a defect portion. A specific set value for the “size enough to reliably catch a defect portion” will be described in embodiments below.

For acquisition of a reference image, a resolution of the reference image may be lower than a resolution of a defect image. A purpose of acquiring a reference image is calculation of a center of a defect, and thus, the required resolution is not as high as that required for defect classification, and accordingly, it is a waste to acquire a reference image with a resolution that is the same as that of a defect image.

“Resolution” here refers to a pixel count per unit area for providing image data, that is, a pixel density of image data, and can be controlled by changing the pixel size with the pixel count fixed or changing the pixel count with the pixel size fixed. Also, the viewing field size is a scanning area in which an electron beam is scanned.

### Advantageous Effect of Invention

The present invention enables provision of a defect observation device that reduces wait time from an end of pickup of a reference image and accompanying processing to a start of pickup of a defect image compared to conventional ones by making a resolution of the reference image be low compared to a pixel count of the defect image in an image pickup unit using an electronic microscope for automatic fine defect classification, whereby a throughput enhanced compared to those of conventional ones can be achieved.

Alternatively, the present invention enables provision of a defect observation device that performs image pickup with a viewing field size of a defect image set to a size wide enough to reliably catch a defect portion and a resolution set to a resolution required for defect classification, whereby observation images of fine defects can be acquired while image acquisition time per defect or time required from acquisition of defect images for a plurality of defects to defect classification are reduced.

Furthermore, image pickup processing and image processing for defect center identification can completely be separated, enabling provision of a defect observation device that can perform off-line ADC.

### BRIEF DESCRIPTION OF DRAWINGS

FIG. 1 is a diagram of an overall configuration of a defect observation device according to embodiment 1.

FIG. 2(A) is a flowchart illustrating an operation of the defect observation device according to embodiment 1.

FIG. 2(B) is a flowchart illustrating an operation of the defect observation device according to embodiment 1.

FIG. 3 illustrates an example of each of a defect image acquired by the defect observation device according to embodiment 1 and a reference image.

FIG. 4 is a diagram illustrating an example configuration of a file storing accompanying information, which is referred to by the defect observation device according to embodiment 1.

FIG. 5 is a schematic diagram illustrating an example of each of a reference image, a defect image, a downsampled image, a difference image and a defect observation image.

FIG. 6 is a diagram of an overall configuration of a defect observation device according to embodiment 2.

FIG. 7 is a diagram illustrating a flow of acquiring a defect image using conventional two-viewing field switching.

### DESCRIPTION OF EMBODIMENTS

### Embodiment 1

Hereinafter, embodiments of the present invention will be described.

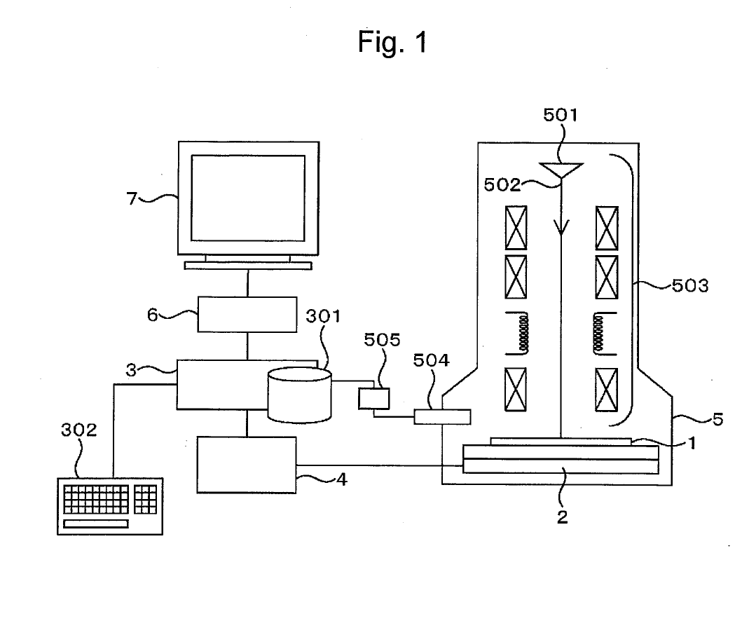

First, FIG. 1 illustrates an overall configuration of an image pickup unit for defect classification using an electronic microscope according to the present embodiment. In FIG. 1, reference numeral 1 is a semiconductor wafer to be inspected, which is secured to an X-Y stage 2. The X-Y stage 2 can be moved in X and Y directions via a control unit 4 in response to control signals from a computer 3.

Reference numeral 5 is an image pickup unit using a scanning electronic microscope (hereinafter referred to as SEM), which picks up an enlarged image of the semiconductor wafer 1. In other words, a primary electron beam 502 emitted from an electron source 501 is made to converge in an electron optical system 503 to scan the primary electron beam 502 on the semiconductor wafer 1, which is a sample, whereby the semiconductor wafer 1, which is a sample to be observed, is irradiated with the primary electron beam 502. Secondary charged particles such as secondary electrons or reflected electrons generated from the semiconductor wafer 1 as a result of the irradiation are detected by the detector 504 to acquire an SEM image of the semiconductor wafer 1. The detector 504 is connected to an A/D converter 505 via a preamplifier, and an analog output signal from the detector 504 is converted into a digital signal by the A/D converter. This digital signal is what is called an image signal, and a signal component corresponding to one pixel in an image signal includes a plurality of binary code strings (pulses). A pixel size, which can be changed by adjusting a scanning speed of the primary electron beam 502 or a conversion rate of the A/D converter, is controlled by the control unit 4.

In the image pickup unit 5, a viewing field of the SEM is moved by controlling the X-Y stage 2, whereby an arbitrary position in the semiconductor wafer 1 can be observed. An image picked up by the image pickup unit 5 is input to the computer 3 and subjected to processing such as defect extraction. A result of the processing is displayed on a monitor 7 via a display switching device 6. The function of the display switching device 6 may be performed by the computer 3. An input device 302, which is connected to the computer 3, is used for setting conditions of operation of the device such as conditions for defect observation and/or conditions for image acquisition as necessary. The detector 504, the computer 3, the control unit 4, the display switching device 6, the monitor 7 and the input device 302 described above are connected via signal transmission lines indicated by solid lines in FIG. 1.

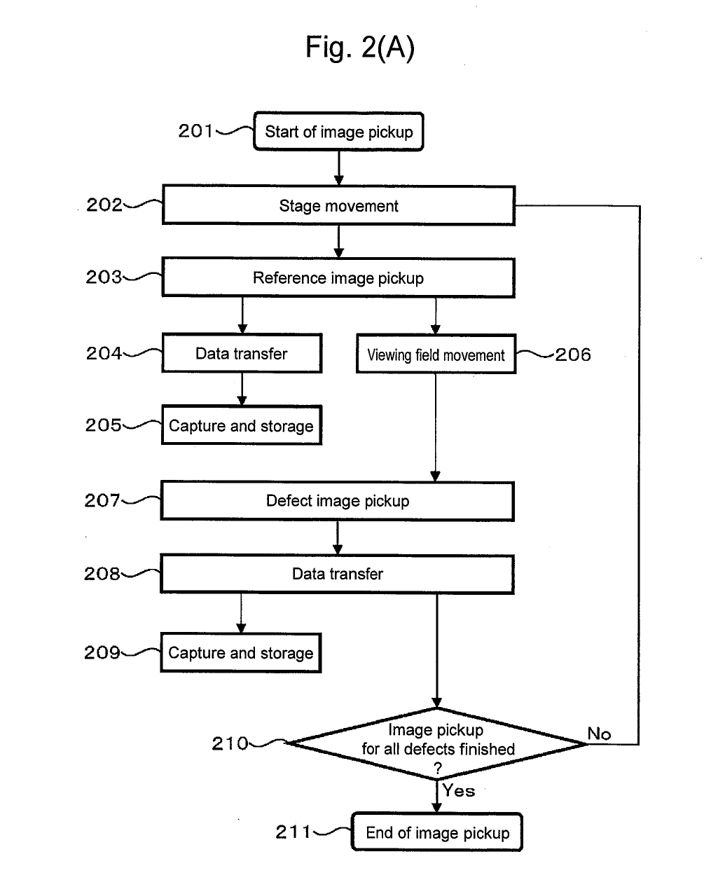

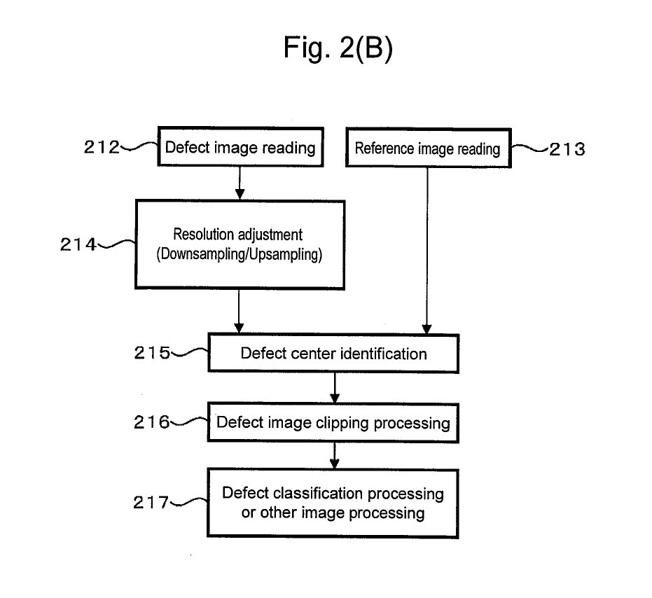

Next, an operation of the image pickup unit for defect classification illustrated in FIG. 1 will be described with reference to FIGS. 2(A) and 2(B). It is assumed that a semiconductor wafer, which is an inspection target, was inspected in advance by a non-illustrated surface defect inspection device such as a foreign substance inspection device or an outer appearance inspection device and coordinate data of a position of, e.g., a foreign substance or a defect has been detected.

A flow of operation of the image pickup unit for defect classification according to the present embodiment is largely divided into the image pickup flow illustrated in FIG. 2(A) and the image processing flow illustrated in FIG. 2(B), and first, the image pickup flow will be described.

Upon start of image pickup in step 201, the semiconductor wafer 1, which is an inspection target, is loaded on the X-Y stage 2, and calibration between a coordinate system for the X-Y stage 2 and a coordinate system for the semiconductor wafer 1 is performed using, e.g., data on a design of a semiconductor or acquired defect position data.

Next, an instruction for driving the X-Y stage 2 based on data on coordinates of a position of a defect in the semiconductor wafer 1 is transmitted from the computer 3 to the control unit 4, and upon receipt of the instruction, the control unit 4 drives the X-Y stage 2. As a result of the X-Y stage 2 being driven, an image pickup position (defect observation position) in the semiconductor wafer 1 is moved to an electron beam irradiation position immediately below the electron optical system 503 (step 202). Subsequently, electron beam scanning is performed according to preset viewing field size and pixel count conditions to acquire a reference image (step 203).

For a position where the reference image is acquired, basically, a position in the semiconductor wafer 1 where a circuit pattern similar to a circuit pattern to be subjected to defect image pickup in step 207 exists is selected. For example, a position in an adjacent chip corresponding to an image pickup position where a defect image is picked up in step 207 or a position in an adjacent memory mat corresponding to a position where a defect image is picked up is selected.

An image signal of the reference image acquired by the image pickup is subjected to data transfer via signal transmission lines (step 204), and captured and then stored in storage means 301 (step 205). At the time of the storage, the acquired image is registered at a position corresponding to a defect ID (serial number provided to each defect) for the defect in a defect image file.

Also, for pickup of the reference image, a position of the X-Y stage 2 is controlled by the control unit 4 so that the defect detected by the surface inspection device falls within a preset viewing field of the image pickup unit 5, and optical conditions of the electron optical system 503 (e.g., the scanning speed and/or the scanning area of the electron beam or the conversion rate of the A/D converter) are controlled according to a preset pixel count and a preset viewing field size.

The data on the coordinates of the position of the defect in the semiconductor wafer 1, which is a destination of the movement of the X-Y stage 2, is a result of an inspection performed in advance by the non-illustrated surface defect inspection device, and is stored together with a defect ID in the storage means 301 of the computer 3.

Upon acquisition of the reference image, in parallel with data transfer, the viewing field is moved by image shifting or stage movement (step 206), whereby a defect image is acquired (step 207). The control unit 4 controls the position of the X-Y stage 2 so that the selected image pickup position falls within the preset viewing field of the image pickup unit 5, and the electron optical system 503 is controlled according to a preset pixel count and a preset viewing field size to acquire the defect image. Image data of the picked-up defect image is transferred (step 208) and then, captured and stored in the storage means 301 (step 209).

Simultaneously, an operation to determine whether or not image pickup of all of defects has been finished is performed (step 210). If the image pickup has not been finished, the flow returns to step 202, and an image of a next defect is picked up, and if the image pickup has been finished, the image pickup flow ends (step 211).

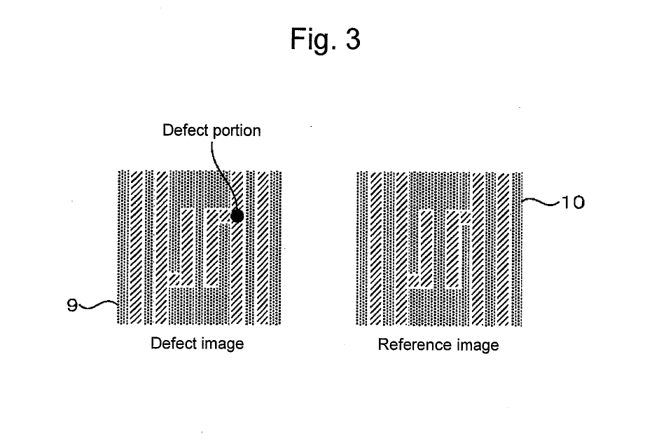

FIG. 3 illustrates examples of an acquired defect image 9 and an acquired reference image 10. It can be seen that both images are ones picked up at positions on the wafer where circuit patterns that are similar to each other or are the same are formed.

Either the defect image or the reference image may be picked up first. If an image for defect classification is acquired for each of a plurality of inspection targets, an image pickup route is set in advance so that image pickup positions in the inspection targets are connected in a shortest way. Consequently, a total movement distance of the stage is reduced, enabling reduction of stage movement time.

In the present embodiment, the viewing field size of the defect image is set to a size enough to reliably catch a defect portion, that is, set to be larger than a viewing field size of a high-magnification image according to the conventional two-viewing field size switching. Simultaneously, a resolution of the defect image is set to a high resolution enough to be used for defect classification. Here, the “size larger than a viewing field size of a high-magnification image according to the conventional two-viewing field size switching” means a viewing field size that is substantially the same as that of a conventional low-magnification defect image, and more specifically, for example, is set to a value obtained by adding a margin set based on an amount of positional difference between the outer appearance inspection device and the defect image observation device to a size of a defect detected by the outer appearance inspection device. It should be understood that such value is an example of the set value, and another set value can be used as long as such other set value is a size enough to reliably catch a defect portion.

The viewing field sizes and the pixel counts (or pixel sizes) of the defect image and the reference image are set by a device operator at the time of inspection condition setting before start of an inspection, and are registered in the storage means 301 as an inspection recipe.

The inspection recipe is set by the device operator via the input device 302 connected to the computer 3. During image pickup or image processing, the content of the set recipe is referred to by the control unit 4 to perform various types of control. Hereinafter, a procedure for setting a viewing field size and a pixel count will be described.

First, the device automatically sets or the device operator manually sets the viewing field sizes of the defect image and the reference image taking, e.g., an error included in the previously-provided defect coordinate data and a stage positioning error into account so that when the viewing field is moved to a position of a defect, the defect falls within the viewing field size. In a case where a plurality of observation points exist in the wafer and it is necessary to successively acquire an image for defect classification for each of the plurality of observation points, it is advantageous from the perspective of throughout that the observation device automatically sets the viewing field size or the pixel count.

In a case where the observation device automatically sets the viewing field size, the viewing field size is set according to attribute information (e.g., size and/or type) for a defect, which is an observation target. For example, if the defect has a large size, the viewing field size is set to provide a wide viewing field, and if the defect has a small size, the viewing field size is set to provide a small viewing field. For device implementation, a viewing field size is determined as a template for each type of circuit patterns and each of defect attributes, and at the time of inspection recipe setting, the computer 3 refers to a defect file in the storage means 301 and selects an optimum viewing field size for a defect of each of defect IDs from the templates. Since it is convenient that a device user can change the correspondence between defect attributes and viewing field sizes, a template editing screen that can be operated by the device user may be displayed on the monitor 7. The correspondence between defect attributes and viewing field sizes means that, for example, a viewing field size a is selected for a defect size of less than A and a viewing field size b is selected for a defect size of no less than A and less than B. On the template editing screen, an input window for numerical values of defect attributes such as A and B and numerical values of viewing field sizes such as a and b above are displayed. The computer 3 is provided with the template editing function, enabling the user to set these values such A, a, B and b.

For the defect attribute information, a result obtained by an inspection performed in advance by the non-illustrated surface defect inspection device is utilized, and the defect attribute information is stored in the storage means 301. Also, the viewing field sizes of the defect image 9 and the reference image 10 may be the same or different from each other.

Upon end of the image pickup processing flow, an image processing flow is executed. The image processing flow may be executed each time an image is picked up for each of the defect positions or each time image pickup of all of the defects has been finished. Although the image processing flow illustrated in FIG. 2 is a flow in which the image processing flow is executed each time an image is picked up for each of the defect positions, if the image processing flow is executed after end of image pickup of all of the defects, the image processing flow is executed after step 211 is reached. Hereinafter, details of the image processing flow will be described.

First, the defect image and the reference image are read from the storage means 301 (steps 212 and 213). When the image processing flow is executed each time an image is acquired for a respective defect position, this read operation is performed after end of the capture processing in step 209.

As described above, the resolutions of the defect image and the reference image are different from each other, and thus, a pixel operation for identifying a center of the defect cannot be performed in such state. Therefore, the computer 3 performs resampling for resolution adjustment for the defect image or the reference image to adjust the defect image to have a resolution that is the same as that of the reference image (step 214). In the below description, it is assumed that the resolution of the defect image is adjusted by downsampling.

Upon execution of step 214, the computer 3 refers to accompanying information 8 (which will be described later), reads set pixel counts of the defect image and the reference image and performs downsampling. Example downsampling methods include image processing methods such as simple thinning-out and linear approximation.

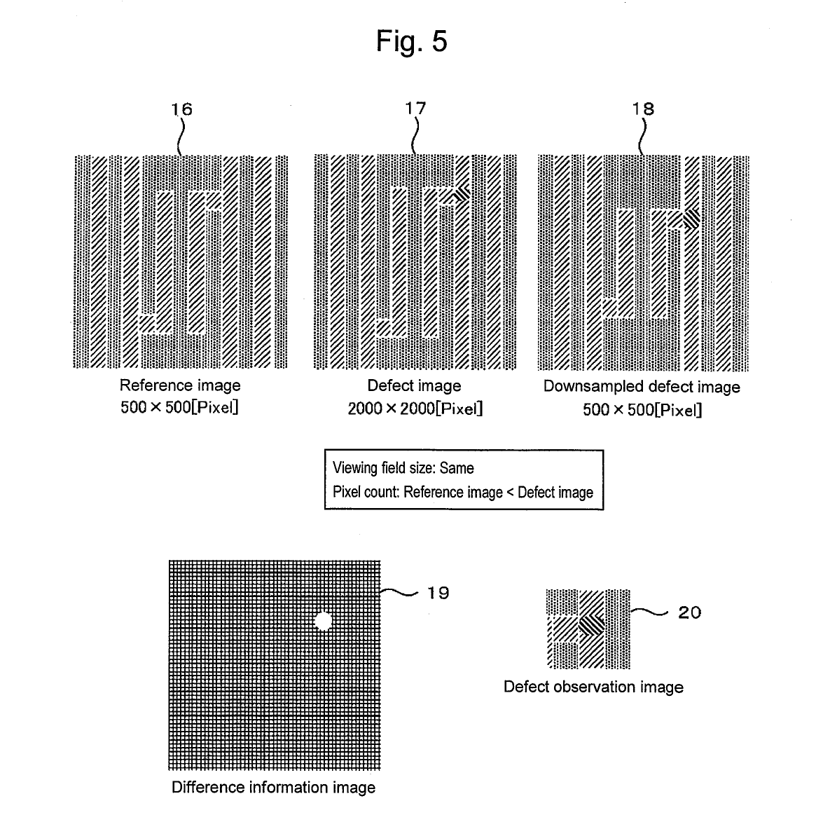

FIG. 5 includes schematic diagrams of a reference image and a defect image, which have viewing field sizes equal to each other and pixel counts different from each other, and a downsampled defect image acquired by downsampling the defect image. In the case of the example illustrated in FIG. 5, the pixel count of the reference image 16 is 500 pixels in both the X and Y directions, and the pixel count of the defect image 17 is 2000 pixels in both the X and Y directions. The reference image 16 and the defect image 17 both have a same viewing field size, that is, an electron beam scanning area, and thus, the size of one pixel of the reference image is four times larger than the pixel size of the defect image.

Although the downsampled defect image 18 and the reference image 16 have the same viewing field size and the same pixel count, in the case of the downsampled defect image, the pixel size is large, and thus, the detect indicated by black dots are expressed to be larger than that of the defect image 17. Also, the outline shape of the defect is expressed to be somewhat deformed compared to that of the defect image 17.

Next, the computer 3 performs pattern matching between the downsampled defect image 18 and the reference image 16 to extract difference image information 19, thereby identifying the position and size of the defect in the downsampled defect image 18. In the case of the present embodiment, the pixel count of the reference image has been reduced to be smaller than the pixel count of the defect image and pattern matching is performed between the downsampled defect image and the reference image, enabling reduction of operation time required for the pattern matching. In this case, as the number of pixels included in each of the downsampled defect image and the reference image is smaller, the calculation costs required for the matching are reduced more.

The position of the defect in the defect image 17 is identified based on the position of the defect in the downsampled defect image 18, which has been acquired from the difference image information 19 (step 215), and an image with the position of the defect as a center in the defect image 17 is clipped off taking the size of the defect into account (step 216). Consequently, a defect observation image 20 suitable for observation of features of the defect is acquired. The defect observation image acquired in step 216 has no difference from a high-magnification defect image ultimately acquired in the conventional image acquisition flow illustrated in FIG. 8. The clipped defect observation image 20 is stored in the storage means 301 and used for acquiring the defect features such as a defect size and a defect type (step 217).

Next, setting of the pixel counts of the defect image and the reference image will be described. In the case of the defect observation device according to the present embodiment, two-viewing field switching including acquisition of a low-magnification defect image for finding a center of a defect and acquisition of a high-magnification viewing field switching for ADC is not performed, and thus, it is necessary that the defect image 9 picked up in step 203 in FIG. 2 have a resolution that can be used for defect classification as it is.

The pixel count of the defect image is automatically set by the computer 3 or manually set by the device operator at the phase of preparing an inspection recipe before start of defect observation according to the necessary resolution and the set viewing field size. Here, the inspection recipe means file data in which, e.g., information and operation procedure necessary for the device to perform defect observation are described.

If the computer 3 automatically sets the pixel counts, the pixel counts are set based on defect attribute information stored in a defect file stored in the storage means 301, for example, defect size information, and if the defect size is large, the pixel count is set to be small, and if the defect size is small, the pixel count is set to be large.

The pixel count of the reference image 10 is set to be smaller than the pixel count of the defect image 9. In principle, the device operates even where a reference image and a defect image have a same pixel count; however, a reference image is an image used only for searching for a center of a defect, and thus, in many cases, it is a waste that a reference image is acquired so as to have a resolution that is the same as that of a defect image. Accordingly, as a result of reduction of the pixel count of a reference image, image pickup time for acquiring the image and pixel operation time during searching for a center of a defect are reduced. Also, a size of a file in which the image is registered can made to be small, and thus, an amount of use of computer resources such as a memory and an image calculation processor can be reduced. For the device implementation, as in the automatic setting of the viewing field size, pixel counts of a defect image and a reference image are determined as a template for each type of circuit patterns and each of defect attributes, and at the time of setting an inspection recipe, the computer 3 refers to the defect file in the storage means 301 and selects an optimum pixel count for a defect of a respective defect ID from the templates.

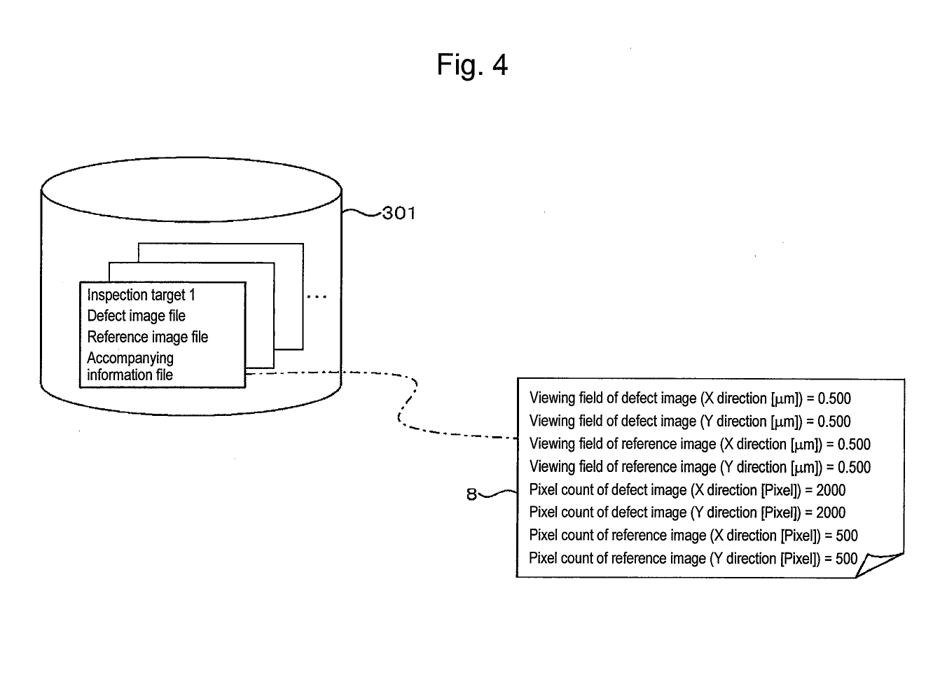

As illustrated in FIG. 4, the set viewing field information and pixel count information may be stored in an accompanying information file in the storage means 301 together with the acquired image as accompanying information 8 so that such pieces of information can be reused in the following image processing flow. FIG. 4 illustrates an example in which viewing field sizes in the X and Y directions of a defect image, viewing field sizes in the X and Y directions of a reference image, pixel counts in the X and Y directions of the defect image and pixel counts in the X and Y directions of the reference image are stored as accompanying information 8.

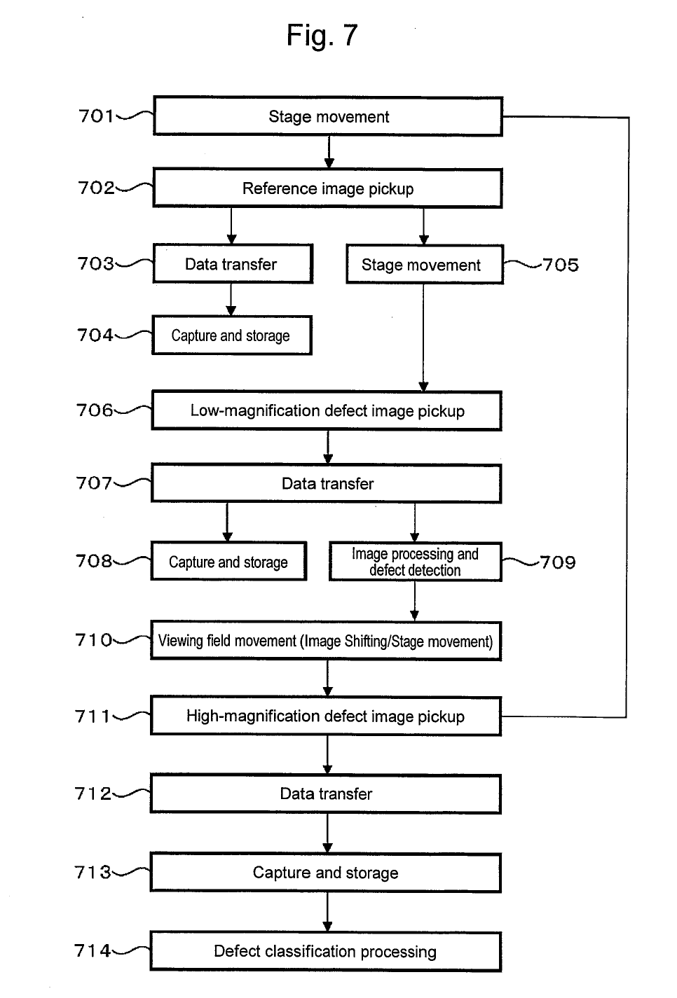

Next, operation and effects of the defect observation device according to the present embodiment will be described while comparing FIGS. 2(A) and 2(B) and FIG. 7.

First, in the case of the present embodiment, the reference image has a reduced pixel count, and thus, scanning time for acquisition of the reference image, time for data transfer from the detector 504 to the storage means 301 and time required for image capture and storage, that is, time for executing each of steps 203, 204 and 205, are reduced compared to time for executing each of step 702, 703 and 704, and time for executing all of steps 203, 204 and 205 is also substantially reduced to around one-fifth of time for executing all of steps 702, 703 and 704.

Regarding time for acquiring a defect image, beam scanning time and image storing time, that is, time of execution of steps 207, 208 and 209 are increased compared to time required for steps 706 to 708 or time required for steps 711 to 713 by the amount of an increase in viewing field size and resolution of the defect image. However, as opposed to the flow in FIG. 7, it is sufficient to pickup a defect image only once, and time for pickup of a defect image is substantially reduced compared to a total of the time required for steps 706 to 708 and the time required for steps 711 to 713.

Also, as a result of the reduction in pixel count of the reference image, time required for data transfer of the reference image in step 204 is reduced, enabling beam scanning performed in step 207 after the viewing field movement in step 206 in the image pickup sequence to be immediately started. Although the data transfer in step 204 and the viewing field movement in step 206 are performed in parallel, if the data transfer time is long, the viewing field movement may be finished first. However, during data transfer for the reference image, the relevant signal transmission lines are occupied by the image data of the reference image, and thus, even if step 207 (pickup of a defect image) is executed, image data of a picked-up defect image cannot be transmitted, resulting in occurrence of wait time from completion of step 206 to start of execution of step 207. In the case of the present embodiment, the wait time from the end of step 206 to start of execution of step 207 can be reduced compared to that in the conventional flow or can be reduced to zero, enabling prevention of delay in start of pickup of a defect image, which is a conventional problem, and reduction in time required for the entire image pickup flow.

Because of the factors described above, in the image pickup method according to the present embodiment, time required for picking up an image of one defect is reduced to that in the conventional method. A defect observation device used in a semiconductor device manufacturing line is demanded to automatically classify a very large number of defects, i.e., several tens to several thousands of defects, and thus, the effect of reduction in effective image pickup time per defect has a very large impact on the overall throughput.

Also, the defect image acquisition sequence according to the present embodiment is easier than the conventional defect image acquisition sequence in terms of the overall management.

In the case of the conventional defect image acquisition sequence illustrated in FIG. 7, after acquisition of a high-magnification defect image in step 711, the data transfer processing in step 712 and the movement of the viewing field to a position of a next defect in step 701 are performed in parallel. However, as described above, during the execution of step 712, the relevant signal transmission lines are occupied by the image data transfer for the previous defect, and thus, even though the stage movement in step 701 has been completed, wait time occurs until start of the processing in step 702 (until the processing in step 712 is completed).

Meanwhile, in the case of the image pickup flow in the present embodiment, image pickup time per defect, that is, the entire processing time from steps 202 to 207 is reduced, allowing enough time for the processing in the entire flow, and thus, as illustrated in FIG. 2(A), the sequence of starting the movement of the viewing field (step 202) to a next defect after completion of data transfer in step 208 can be provided. Accordingly, no extra wait time occurs between pickup of an image of a certain defect and pickup of an image of a next defect, whereby the image pickup flow becomes efficient and timing control for the respective steps included in the image pickup flow is facilitated compared to that of the conventional technique. As a result, e.g., a program for performing timing control for the image pickup flow is also simplified.

Furthermore, the defect image acquisition sequence in the present embodiment has the characteristic of being able to perform image pickup and image processing separately.

In the conventional flow in FIG. 7, a defect image and a reference image are acquired using a low-magnification viewing field, and a center of a viewing field of a high-magnification defect image is determined by identifying a center of a defect by processing for operation for comparison between both. Accordingly, the high-magnification defect image acquisition step in step 711 cannot be executed unless step 709 ends.

Meanwhile, the flow according to present embodiment, which is illustrated in FIGS. 2(A) and 2(B), a high-magnification defect image to be used for ADC is acquired by clipping a desired area including a center of a defect from the defect image acquired in step 207 (step 214 in FIG. 2), eliminating the need for another scanning of an electron beam to perform image pickup.

In other words, in the flow according to the present embodiment, it is possible to perform image pickup and image processing completely separately from each other, and thus, the overall throughput can be enhanced compared to the conventional flow by the amount of image pickup and image processing being able to be performed in parallel. Also, such a flexible device operation that the image pickup unit 5 is dedicated to image pickup and image processing for defect center identification and defect image clipping are performed at optimum timings can be performed.

Although the above description has been provided in terms of an example in which a defect image is downsampled to form an image for defect center searching, in principle, a method for searching for a center of a defect by upsampling a reference image (interpolation approximation) or downsampling a defect image and upsampling a reference image using a pixel count X, which is in the relationship of pixel count of reference image<pixel count X<pixel count of defect image; however, the method of downsampling a defect image provides the advantage of reduction in calculation costs. Furthermore, although the above embodiment has been described on the premise that the resolutions of a reference image and a defect image are changed by changing the pixel counts with the pixel sizes fixed, it should be understood that similar control can also be performed by changing the pixel sizes with the pixel counts fixed.

### Embodiment 2

As illustrated in FIGS. 2(A) and 2(B), in the flow described in embodiment 1, a high-magnification defect image used for ADC is one acquired by clipping a desired area including a center of a defect off from an acquired defect image, enabling image pickup and image processing to be separated from each other. In other words, image processing for ADC is not necessarily needed to be performed when an observation sample is placed in a sample chamber. Therefore, the present embodiment will be described in terms of an example configuration for off-line ADC in which image processing for ADC and image pickup are completely separated from each other.

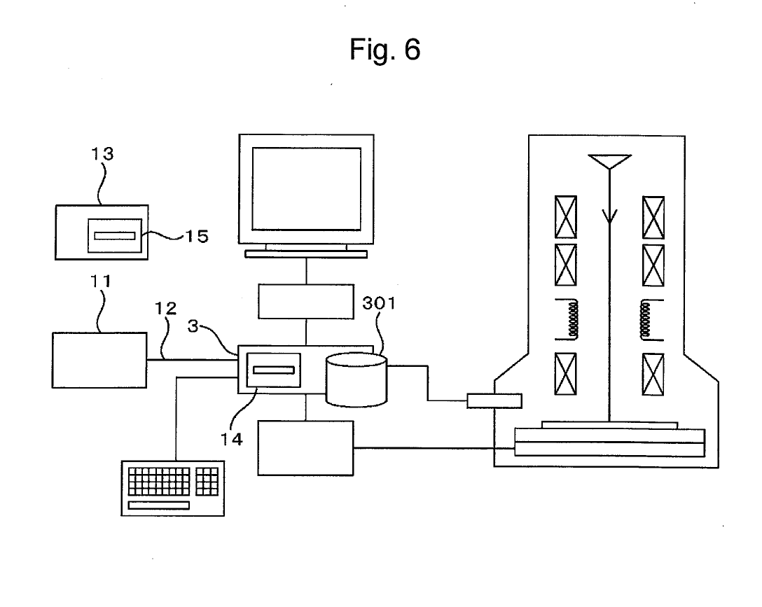

FIG. 6 illustrates an overall configuration of a defect observation device according to the present embodiment. In FIG. 6, reference numerals of parts that are the same as those of FIG. 1 are omitted, and only parts that are different from those of FIG. 1 are provided with reference numerals.

The defect observation device illustrated in FIG. 6 includes a defect feature acquiring unit 11 connected to a computer 3 via a network cable 12, and a defect feature acquiring unit 13 separated from the computer 3.

In storage means 301 connected to the computer 3, a reference image and a defect image acquired in defect observation and accompanying information 8 illustrated in FIG. 4 are stored. The defect feature acquiring units 11 and 13 each have a function that refers to the acquired images and the accompanying information 8.

In the case of the present embodiment, real-time image processing is not necessary, respective drive devices 14 and 15 for a portable recording medium can be mounted in the computer 3 and the defect feature acquiring unit 13, and through the portable recording medium, the reference image, the defect image and the accompanying information stored in the storage means 301 are moved to the defect feature acquiring unit 13.

The defect feature acquiring unit 13 performs ADC and defect feature extraction using the reference image, the defect image and the accompanying information 8 recorded in the portable recording medium.

Also, it should be understood that ADC and defect feature extraction can be performed by acquiring a reference image, a defect image and accompanying information from the computer 3 via the network cable 12 (that is, not via a portable recording medium) in the same way as the defect feature acquiring unit 11.

In the case of the present embodiment, wafer inspection (image pickup and collection) can be made to proceed without waiting for completion of ADC processing, enabling an increase in number of wafers that can be inspected in unit time. Also, an off-line ADC environment has a simple hardware configuration compared to that of the device body and can easily be reinforced, enabling easy reduction in ADC processing time.

### REFERENCE SIGNS LIST

1 semiconductor wafer
2 X-Y stage
3 computer
4 control unit
5 image pickup unit
6 display switching device
7 monitor
8 accompanying information
9, 17 defect image
10, 16 reference image
11, 13 defect feature acquiring unit
12 network cable
14, 15 drive device for portable recording medium
18 downsampled defect image
19 difference information image
20 defect observation image
301 storage means
302 input device
501 electron gun
502 primary electron beam
503 electron optical system
504 detector

1. A defect observation device for acquiring an image of a predetermined area of a sample mounted on a sample stage to observe a defect existing in the sample, the defect observation device comprising:
image acquiring means for scanning a primary charged particle beam on the predetermined area and outputting an image based on a detected secondary charged particle;
control means for controlling an operation of the image acquiring means; and
defect determining means for comparing the image of the predetermined area and a reference image to calculate a center position of a defect existing in the predetermined area,
wherein the control means controls conditions for acquisition of the defect image and the reference image so that a resolution of the reference image is lower than a resolution of the defect image.

2. The defect observation device according to claim 1, wherein the control means controls the conditions for acquisition of the defect image and the reference image so that a pixel count of the reference image is smaller than a pixel count of the defect image.

3. The defect observation device according to claim 1, wherein the defect determining means performs downsampling processing on the defect image and compares the downsampled defect image and the reference image to calculate the center position of the defect.

4. The defect observation device according to claim 1, wherein the defect determining means performs upsampling processing on the reference image, and compares the defect image and the unsampled reference image to calculate the center position of the defect.

5. The defect observation device according to claim 1, wherein the control means further controls the conditions for image acquisition of the defect image and the reference image so that viewing field sizes or scanning areas of both are substantially equal to each other.

6. The defect observation device according to claim 1, wherein the control means changes the resolution of the reference image and the resolution of the defect image by making a scanning speed of the primary charged particle beam be different between the defect image and the reference image.

7. The defect observation device according to claim 1, wherein the defect observation device is capable of executing
a first operation mode in which defect observation is performed with the resolution of the reference image made to be lower than the resolution of the defect image, and
a second operation mode in which defect observation is performed with the resolution of the reference image made to be equal to the resolution of the defect image.

8. The defect observation device according to claim 7, wherein time required for defect observation in the first operation mode is shorter than time required for defect observation in the second operation mode.

9. The defect observation device according to claim 1, comprising a management console on which an input screen for making an input to set a pixel count of each of the reference image and the defect image is displayed.

10. The defect observation device according to claim 1, comprising information processing means for performing information processing using a defect file including a defect ID of the defect existing in the sample and information on a position of the defect corresponding to the defect ID and attribute information for the defect,
wherein the defect observation device has a function that sets a pixel count of each of the defect image and the reference image for a defect with a predetermined defect ID based on the attribute information for the defect.

11. The defect observation device according to claim 10, wherein information on a size of the defect is used as the attribute information for the defect.

12. A defect observation device for acquiring an image of a predetermined area of a sample mounted on a sample stage to perform processing for classifying a defect existing in the sample based on the image, the defect observation device comprising:
a charged particle optical column that scans a primary charged particle beam on the predetermined area and outputs an image based on a detected secondary charged particle;
control means for controlling an operation of the charged particle optical column; and
defect determining means for comparing the image of the predetermined area and a reference image to calculate a center position of a defect existing in the predetermined area,
wherein the defect image used for processing for calculating the center position is acquired with a resolution usable for the processing for classifying the defect.

13. The defect observation device according to claim 12, comprising image storage means for storing a result of an operation by the defect determining means,
wherein the defect determining means clips off an area including the calculated center position from the defect image and stores the area in the image storage means.

14. The defect observation device according to claim 13, comprising defect classification processing means for performing processing for classifying the defect using the clipped defect image stored in the image storage means.

15. A defect observation method comprising the steps of:
scanning a primary charged particle beam on a predetermined area of a sample mounted on a sample stage to form an image based on a detected secondary charged particle; and
comparing the image with a predetermined reference image to calculate a center position of a defect existing in the predetermined area,
wherein conditions for acquisition of the image of the predetermined area and the reference image are controlled so that a resolution of the reference image is lower than a resolution of the defect image.

16. The defect observation method according to claim 15, comprising:
clipping off an area including the calculated center position from the image; and
performing processing for classifying the defect using the clipped image.
